(19) United States
(12) Patent Application Publication
(10) Pub. No.: US 2016/0029000 A1
(43) Pub. Date: Jan. 28, 2016

(54) Image Recording System with a Rapidly Vibrating Global Shutter CMOS Sensor

(71) Applicant: Reimar LENZ, Munich (DE)

(72) Inventor: Reimar LENZ, Munich (DE)

(21) Appl. No.: 14/803,436

(22) Filed: Jul. 20, 2015

(30) Foreign Application Priority Data
Jul. 28, 2014 (DE) 10 2014 214 750

(51) Int. Cl. H04N 9/04; G02B 5/20; G02B 21/36; H04N 5/265

(52) U.S. Cl. CPC H04N 9/045; H04N 5/265; G02B 5/208; G02B 21/367

(57) ABSTRACT

Image recording system, having: a digital camera with a two-dimensional global shutter CMOS sensor array with photosensitive sensor elements; shifting means, which are configured to produce a relative shifting between an object image and the sensor array between two positions; and a control unit, which is configured to control the shifting means between the recording of successive partial images, taking into account a color mosaic filter placed in front of the sensor elements for the simultaneous recording of a red, green, and blue color separation in such a way that by means of successive partial images recorded at the two positions for all image points of an image obtained by combining the partial images, color information for green is available; and an image processing unit, which is coupled to the digital camera and is configured to calculate a result image or a result image sequence, which includes at least two result images, based on at least three successive partial images.

The present disclosure generally relates to the field of optoelectronic color image converters and in particular an image recording system with a digital camera with a rapidly vibrating global shutter CMOS sensor, which is equipped for motion-compensated color image recording and/or an improved brightness dynamic range.

### BACKGROUND

DE 38 37 063 C1 discloses an optoelectronic color image converter having: an imaging system that produces an image of an object on a two-dimensional CCD array, whose photosensitive flat elements are preceded by a color mosaic mask for recording a red, green, and blue color separation; means for shifting the image between the recording of individual partial images relative to the CCD array such that light elements of the CCD array that are sensitive to red, green, and blue are placed one after the other onto the same image location; and a control unit that produces a congruent combination of the color separation images that have been recorded with the shifted CCD array.

U.S. Pat. No. 6,046,772 A discloses a digital camera with a color sensor, half of whose pixels are photosensitive to a first primary color, typically green. Of the other half of the pixels, half are sensitive to a second primary color and half are sensitive to a third primary color, typically red and blue, respectively. In addition, the green pixels are geometrically arranged, typically in a checkerboard, so that by a lateral shift of the sensor by the width of a single pixel, each of the individual green pixels comes to lie in a position previously occupied by a red or blue pixel. By shooting the same scene twice, with the sensor being shifted by one pixel between the first and second shot, each pixel of the scene is recorded by a pixel that is sensitive to green. This permits a simple and practically error-free reconstruction of the one missing color red or blue at each pixel of the scene.

DE 100 33 751 B4 discloses a digital high-resolution cine-film camera having a recording holder for conventional replacement lenses; a single flat CMOS sensor with sensor elements and a color mosaic filter mask and an optically acting low-pass filtering device for suppressing color moiré interference or color aliasing interference phenomena that are typical for individual flat sensors with color mosaic filters by selectively using motion blurring due to two-dimensional shifting of the sensor in the image plane during the exposure time.

DE 197 02 837 C1 discloses a digital color camera having a CCD sensor, with which, in order to record a color image, two partial images are recorded spaced chronologically apart by an interval that is shorter than a span of time that is required to read out a partial image from the sensor. As a result, between the recording of the two frames, the spectral characteristic is converted at least for a part of the pixels of the color picture to be produced so that different color separations can be obtained in succession from one and the same pixel. The spectral characteristic can also be changed by shifting the CCD sensor in a particular direction and by a particular amount relative to the object image. The chronological distance between the recordings of the two partial images in this case should be small enough that a moving object and therefore the associated object image cannot significantly shift relative to the CCD sensor. In one embodiment, in order to completely avoid color aliasing interference, three partial images in rapid succession are used to produce three complete color separations. To that end, the spectral characteristic of the CCD sensor, relative to pixel of the image that is produced, is changed twice, i.e. respectively between the first and second partial image and between the second and third partial image. This can take place by shifting a CCD sensor two times; the CCD sensor is shifted to three different positions.

### SUMMARY

It may be an object to provide an improved image recording system, which even with moving or otherwise changing scenes, e.g. with fluctuations in brightness, achieves a performance with regard to color interference that is equivalent to comparable multiple-chip cameras and known high-resolution color cameras.

This object is attained with the features of the independent claim. Other features and details ensue from the dependent claims, the description, and the drawings.

A digital image recording system essentially has a digital camera and an image processing unit. Basically, the image processing unit can be integrated into the digital camera. Alternatively, the image processing unit is embodied as an external image processing unit that it coupled via a data communication connection to the digital camera. Depending on the requirements and the application field, the data communication connection can be embodied as wired (data cable) or wireless (radio connection).

The digital camera comprises: (i) a two-dimensional global shutter CMOS sensor array with photosensitive sensor elements, (ii) at least one shifting actuator, which is configured to produce a relative shift between an object image and the sensor array between two positions, and (iii) a control unit that is configured to control the at least one shifting actuator between the recording of successive partial images—taking into account a color mosaic filter placed in front of the sensor elements—to simultaneously record a red, a green, and a blue color separation of the object image so that by means of partial images recorded at the two positions, color information for the color green exists for all image points (pixels) of an image obtained by combining them.

The image processing unit may be coupled to the digital camera, for example via a data communication connection, with the control unit, and may be configured to calculate a single result image or a result image sequence that comprises at least two result images, based on at least three successive partial images recorded at the two positions at equidistant time intervals, with the first and third partial image being recorded at the same position.

In this context, “taking into account a color mosaic filter placed in front of the sensor elements” means that the—usually regular—arrangement of the color filter elements that are required for the individual color separations is decisive for how the at least two positions of the shifting can be selected in order, through the combination of two partial images, to obtain the color information for the color green for each image point (pixel). For example, the CMOS sensor array can be equipped with a Bayer color mosaic filter in which in 50% of the sensor elements, in an arrangement like either the white or black fields of a checkerboard, a color filter element for green-colored light is provided, and in 50% of the remaining sensor elements, a color filter element for red-colored light, and in the other 50% of the remaining sensor elements, a color filter element for blue-colored light is provided. A green color filter causes light from the light spectrum associated with the color green to strike the associated sensor element so that the sensor element emits a sensor signal that corresponds to the intensity of the green light that strikes this sensor element. The same is true for the red and blue color filter elements. Preferably, the sensor elements of the CMOS sensor array are arranged so that they are spaced apart equidistantly in the vertical and horizontal directions. Thus with a Bayer color mosaic filter, for the relative shift between the two positions, a shift between the object image and the sensor field can be produced by one sensor element in the vertical or horizontal direction, i.e. a shift of the sensor array by one image point raster spacing in the horizontal or vertical direction.

The global shutter CMOS sensor array is a CMOS image sensor or CMOS photo sensor with a global shutter characteristic. In connection with photography, the English term “shutter” means a device that allows light to pass for a determined period of time. In earlier cameras, such a shutter was either a central shutter situated in the aperture plane in the lens or a slit shutter immediately in front of the film plane, which protects the film from light. By opening the shutter, it was possible to expose the film to light for a set interval of time (exposure time) and thus for it to be exposed (exposure). Through a photochemical process in the film material, the image was stored on the film. At the end of the exposure time, the shutter is closed again and the film, which is kept in the dark, is wound further. In the digital camera the CMOS sensor array is placed at the location of the film. If all sensor elements of the CMOS sensor array are exposed simultaneously, then this corresponds to the exposure process of conventional film with a central shutter. In other words, the exposure takes place globally and not at different times for different parts of the image. The use of the CMOS sensor array with a global shutter makes it possible with a vibrating sensor array to achieve a higher recording rate of partial images that are not motion-blurred since the read time of the sensor does not have to be taken into account, contrary to a CMOS sensor array with the easier-to-produce and therefore currently still conventional rolling shutter characteristic, which corresponds to the conventional image recording with a slit shutter.

In order to improve the imaging quality of color result images a per se known infrared (IR) barrier filter element can be situated in front of the sensor array. The IR barrier filter element can, for example, be an interference filter or colored glass filter. With the IR barrier filter element, it is possible to avoid or reduce the incidence of infrared light on the sensor elements. It is thus possible to avoid interfering influences of IR radiation on the imaging quality of the sensor array. Interfering influences can be blurs or color distortions. The IR barrier filter can be installed in the digital camera in stationary fashion (i.e. so that it does not move during operation). The IR barrier filter can also be a separate part that is inserted between the digital camera and a lens of the camera or can be attached to the lens. The IR barrier filter can also be a component of a lens, which can be coupled to the digital camera or is affixed to the latter.

With the sensor array of the digital camera, at least three exposures that are shifted relative to one another by one image point raster spacing can be recorded as partial images. In other words, a first shot A₁ in a first position A, a second shot B₂ in a second position B, and a third shot A₃ once again in the first position A. The partial images may be successive partial images. In the present description, the capital letters A and B refer to the two positions of the relative shift and a numerical value following the capital letters indicates the chronological sequence of the corresponding partial image.

The change between the positions A and B, i.e. the relative shift between the object image and the sensor array, may take place between the exposure intervals or two successive exposures, for example by means of a shifting of the sensor array in the image plane. To this end, the at least one shifting actuator for the sensor array can be embodied, for example, as actuators in the form of piezoelectric elements that can be triggered by means of the control unit. With the aid of corresponding control voltages, the control unit can trigger a selective length change of the piezoelectric elements, which according to the arrangement of the piezoelectric elements between the sensor array and a mounting of the sensor array, results in the desired position shift. During the individual exposures, i.e. the recording of the partial images, the sensor array can be stationary or still. In other words, the sensor array vibrates; for the functions that are of interest first, it can be shifted in the image plane between the individual global exposures and can be still during the individual exposure.

By means of the partial images thus recorded in the two positions, in addition to color information for the colors red or blue, it is possible to obtain the color information for green for each image point (pixel). In other words, because of the known structure of the color mosaic filter and the shifting that is oriented thereon, by means of the two partial images, color information for green can be obtained for each image point) and at least color information for a second primary color, red or blue. First of all, this may facilitate the calculation of the missing third color, red or blue, for each respective image point. In addition, the quality of the resulting color result image may be better. The image recording system thus may achieve the performance of a conventional system with a three-chip camera, i.e. a camera with an individual photo sensor for each of the three primary colors red, green, and blue. Furthermore, with the image recording system, no or at least hardly any color moiré interference or color aliasing interference phenomena occur.

The image recording system can be configured for an operating mode for recording a single result image. In this case, the image processing unit prorates or combines the at least three partial images A₁, B₂, and A₃ in order to produce a single color result image.

By contrast with a digital camera of the prior art, e.g. as is known from U.S. Pat. No. 6,046,772 A, the here disclosed image processing unit of the image recording system is configured to combine at least three successive partial images, recorded in alternation at the two positions at chronologically equidistant times, into a single color result image (or into at least two color result images of a result image sequence, as described herein later). With respect to various goals, this achieves additional advantages that will be explained below in conjunction with particular exemplary embodiments of the image recording system.

It has turned out that with a moving scene or a moving camera, it can be advantageous to use at least three successive partial images (exposures) in order to calculate a color result image. The inventor has realized that an object that is moving at a constant speed has the same center-of-gravity locus in the middle partial image as it does in an averaged partial image calculated based on the first partial image and the third partial image. In this case, the first partial image and the third partial image, which were recorded at the same position, can first be combined to produce an (intermediate) partial image, for example through a simple averaging (50% of the first partial image and 50% of the third partial image). The color result image may then in turn be calculated based on the combined partial images, i.e. the intermediate partial image, and the middle—in this case second—partial image. Through this method, even with a moving object or a moving camera in a first approximation, the corresponding green color information at each image point (pixel) can be obtained as a prerequisite for the quality of the resulting color result image discussed above.

Alternatively or in addition, the image recording system can be configured for an operating mode for recording an image sequence. For example, in the operating mode, the image processing unit of the image recording system can be configured to record a result image sequence and to combine each partial image with its two preceding partial images in order to produce a color result image of the result image sequence. In other words, each first partial image A₁ and third partial image A₃ are averaged (e.g. 50% of A₁ and 50% of A₃=A*) and then combined with the second partial image B₂; i.e. a first partial image A₁ at position A, a second partial image B₂ at position B, and a third partial image A₃ once again at position A may be used as a basis for calculating a first color result image E₁ of the result image sequence. The next image E₂ of the result image sequence may be calculated in a similar fashion based on the second partial image B₂ at position B, the third partial image A₃ at position A, and a fourth partial image B₄ at position B. In other words, A₃+B₄+A₅→image E₃, B₄+A₅+B₆→image E₄, . . . , etc. In this way, it may be possible to achieve an image rate that is as high as the exposure rate.

According to the principle of the modifications discussed above, the image processing unit of the image recording system can be configured to combine an arbitrary number of greater than three successive partial images recorded at the two positions at chronologically equidistant times in order to produce a color image.

The combination of more than three successive partial images may be particularly suitable with very fast-reading sensor arrays with correspondingly high exposure rates. It may be particularly advantageous in this case that it is even possible to set a desired image rate of the result image sequence that is lower than the image rate of the partial images.

The inventor has also realized that if a higher number of successive, suitably weighted partial images (exposures) are used for calculating a color result image, the requirement of the “corresponding green color information at each image location” can be met to a particularly advantageous degree. For example, according to the principle of the image processing unit described here, it is also possible to prorate or combine an even number, e.g. four successive partial images, in order to produce a color result image of a result image sequence, for example by combining the partial images A₁ and A₃, e.g. through a weighted averaging (25% of A₁+75% of A₃=A*) and similarly combined partial images, i.e. partial images B₂ and B₄ produced through weighted averaging (75% of B₂+25% of B₄=B*), can be prorated or combined in order to produce a color result image of the result image sequence.

It should be noted that the weighting of the individual partial images to be combined may be carried out so that the average exposure time for the averaged image A* obtained from the partial images at position A (partial image series Ai) coincides with the average exposure time for the averaged image B* obtained from the partial images at position B (partial image series Bi).

With partial images that are recorded at chronologically equidistant times, the above-mentioned weights meet this requirement, as demonstrated by the following sample calculation for the average exposure time: 25% x·1 sec+75%·x 3 sec=2.5 sec=75%·x 2 sec+25%·x 4 sec; in this sample calculation, it has been assumed that the partial image A₁ was recorded at exposure time t=1 sec, the partial image B₂ was recorded at time t=2 sec, the partial image A₃ was recorded at t=3 sec, and finally the partial image B₄ was recorded at t=4 sec.

It has also turned out that the highest possible number of partial images for calculating a color result image may not only be advantageous for movement compensation due to the tight chronological interaction of the partial image sequences, but therefore also may make it possible to increase the brightness dynamics. The brightness dynamic range of the digital camera is based on the ratio of the maximum detectable brightness and the noise in the dark image regions. For example if nine (n=9) partial images are recorded in a total of 90 msec (e.g. five in position A and four in position B, each with 10 msec exposure time and ignoring the shifting time for the sensor array), the noise is added in an uncorrelated fashion, i.e. increases by only a factor of three (=root (9)=3). On the other hand, due to the shortened partial image exposure times, the scene brightness can be greater by the full factor of nine, as in the case of a single exposure of 90 msec in duration, before sensor elements of the sensor array reach saturation.

The control unit of the digital camera can additionally or alternatively be used for setting a brightness dynamic range. In this case, the control unit can be configured, in order to set a brightness dynamic range, (i) to set a number n of partial images, where n is greater than or equal to three, for calculating a result image or a single result image of a result image sequence and (ii) to set the exposure time for the n partial images so that the sensor elements of the sensor array do not reach saturation.

For the recording of a movie with a required image rate of 24 frames/sec, it can therefore be useful to record the scene at for example 96 frames/sec and then to average and prorate or combine them in a correspondingly weighted fashion.

It has also turned out that due to the chronological interaction of a plurality of partial images, it may be possible not only to largely compensate for uniform movements. It may be thus also possible to compensate for a uniform change over time of the image brightness, as can occur, for example, due to a change in the exposure intensity of the scene or due to the optical whitening of fluorescent colorants in microscopy. In other words, the above-explained operating mode of the digital camera is suitable for a film camera for producing image sequences, but is also equally suitable for producing high-quality images in microscopy.

In a modification, the image recording system may be configured, alternatively or additionally, for a black and white or B/W operating mode. In this case, the control unit and/or the image processing unit may be configured, by means of the partial images recorded at the two positions, to deduce the luminance information, which is respectively required for a B/W result image, for each image point (pixel) by combining the existing color information for green for the image point, the at least one additional existing color information for red or blue, and the calculated third color information in the fashion of a maximum operator. As mentioned above, for each image point, the respectively missing third color information red or blue can be calculated based on the two pieces of color information that exist for each image point.

With this measure, the CMOS sensor array (e.g. with a Bayer color mosaic filter mask) can be used to obtain B/W images with the full physical resolution of the sensor array. For each image point, a sensitivity curve over virtually the entire frequency range of visible light may be achieved by establishing the B/W result image based on the color result image of the CMOS sensor array as a maximum of the three color channels of the respective image point. The spectral sensitivity curve may thus approximate the envelope curve of the individual curves.

If the digital camera is equipped with the above-mentioned IR barrier filter element as an integrated component, then in addition, at least one actuator can be provided, which is coupled to the IR barrier filter element and is configured to position the IR barrier filter element in front of the sensor array, particularly by means of pivoting and/or sliding, or moving it away from the sensor array. The IR barrier filter element can thus be moved out of the beam path of light that strikes the sensor array during the recording. For example, the actuator can pivot and/or slide the IR barrier filter element out of the beam path. The control unit or the image processing unit is preferably configured to remove the IR barrier filter element in front of the sensor array in the B/W operating mode. It is thus possible in the B/W operating mode for the sensor elements to also sense the long-wave components of the incident light spectrum. It should be noted that the actuator is optional.

The B/W operating mode may be particularly suitable for a dual-mode camera system, as is frequently required for microscopy.

In the B/W mode, the image recording system is able, by means of the CMOS sensor array, to produce a B/W image with the full physical resolution of the sensor array despite the presence of the color mosaic filter. Through the combination of at least three partial images for a single result image, hardly any interfering uniform chronological changes or movements appear.

### PREFERRED EXEMPLARY EMBODIMENTS

Other advantages, features, and details of the present disclosure ensue from the following description, in which exemplary embodiments are described in detail with reference to the drawings. In this connection, the features mentioned in the claims and in the description can each be essential individually in and of themselves or in any combination. In the same way, the features mentioned above and explained in greater detail below can each be used individually in and of themselves or in any combination or collectively in any combination. Some parts or components that are functionally similar or identical have been provided with the same reference numerals. The terms “left,” “right,” “up,” and “down” used in the description of the exemplary embodiments relate to the drawings in an orientation in keeping with a normally readable description of the drawings and normally readable reference numerals. The embodiments shown and described are not to be taken as exhaustive, but instead have an exemplary character for purposes of explaining the embodiments. The purpose of the detailed description is to provide information to the person skilled in the art, which is why known circuits, structures, and methods are not shown or explained in detail in the description so as not to interfere with the comprehension of the present description.

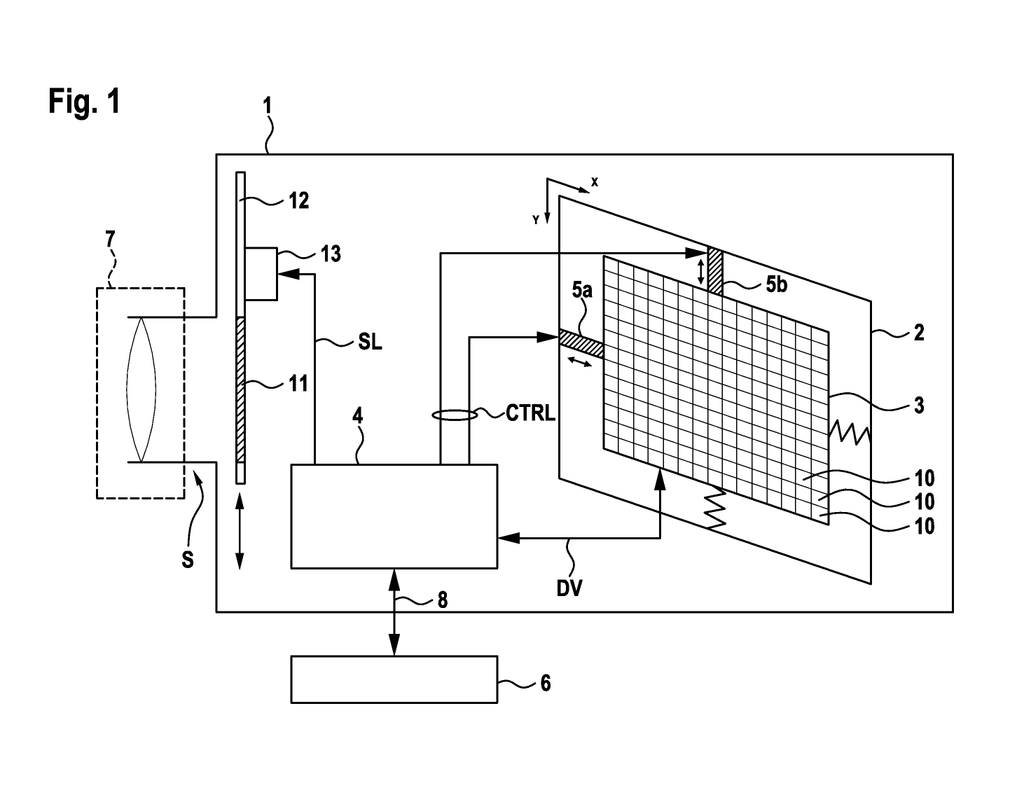

FIG. 1 is a block circuit diagram of an exemplary embodiment of an image recording system with a digital camera and an external computing unit for implementation of different operating modes, which has a CMOS photo sensor that is supported so that it can be slid horizontally and vertically.

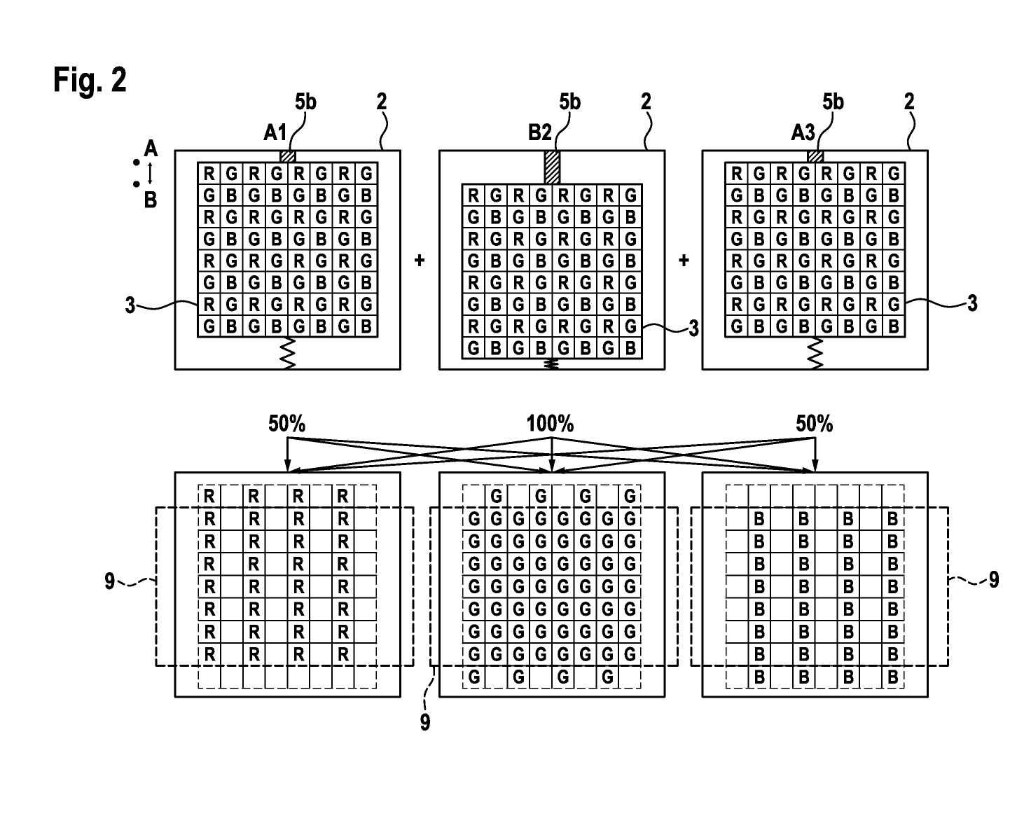

FIG. 2 shows a detail of the surface of the CMOS photo sensor from FIG. 1, indicating a back and forth sliding between two positions A and B and the color information for each image point (pixel) that has been obtained from the weighted partial images.

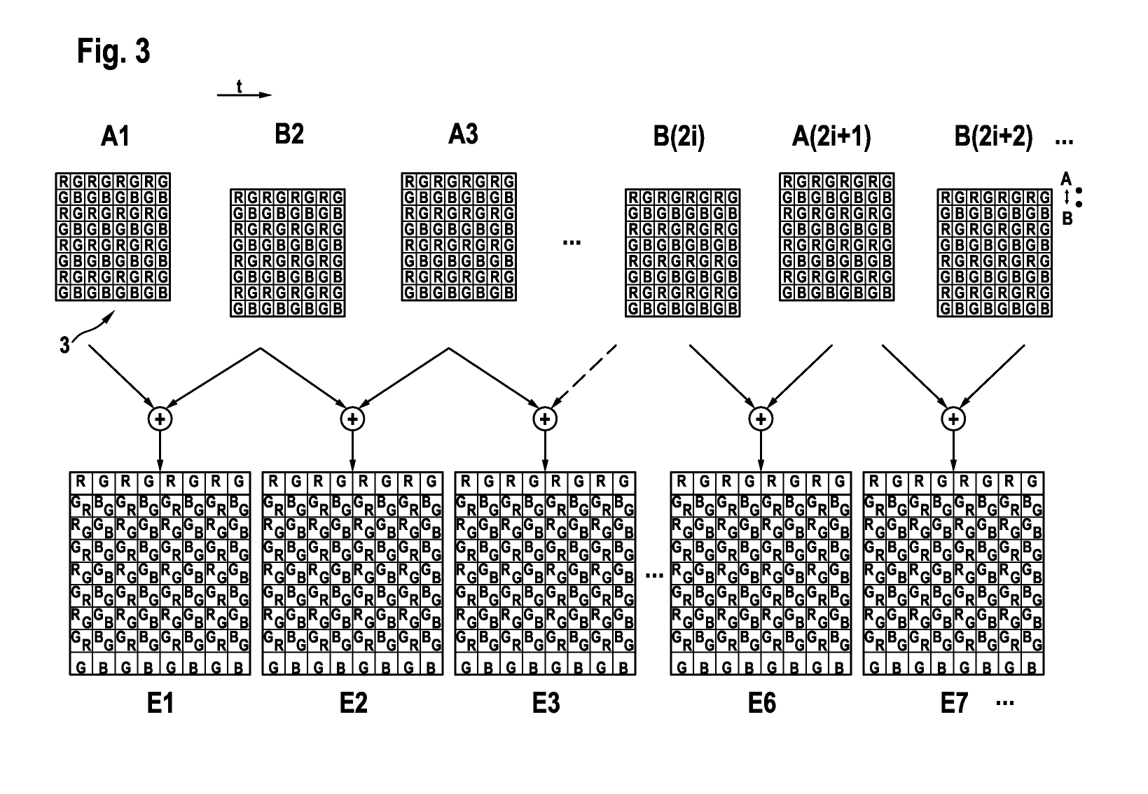

FIG. 3 shows the combination of two respective successive partial images of a sequence of recorded images in order to produce a result image sequence with the same image rate.

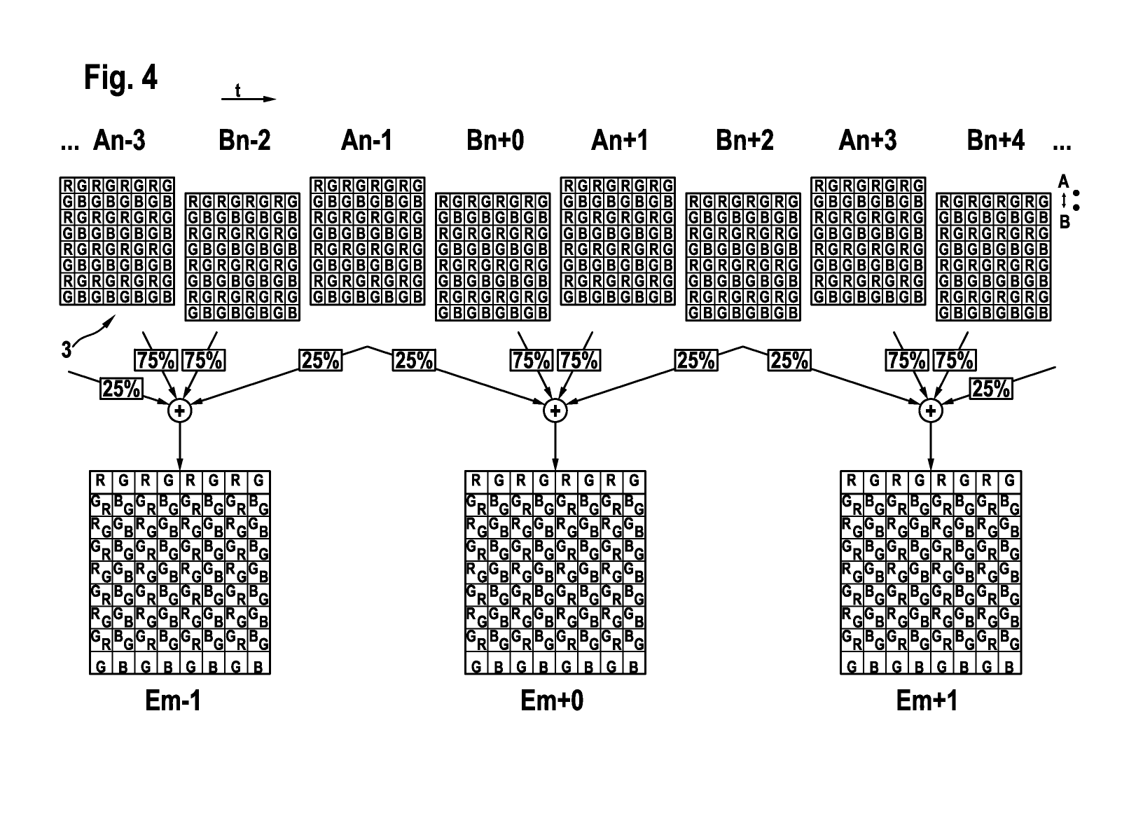

FIG. 4 shows the combination of four respective successive partial images of a high-frequency sequence of recorded images in order to produce a low-frequency result image sequence.

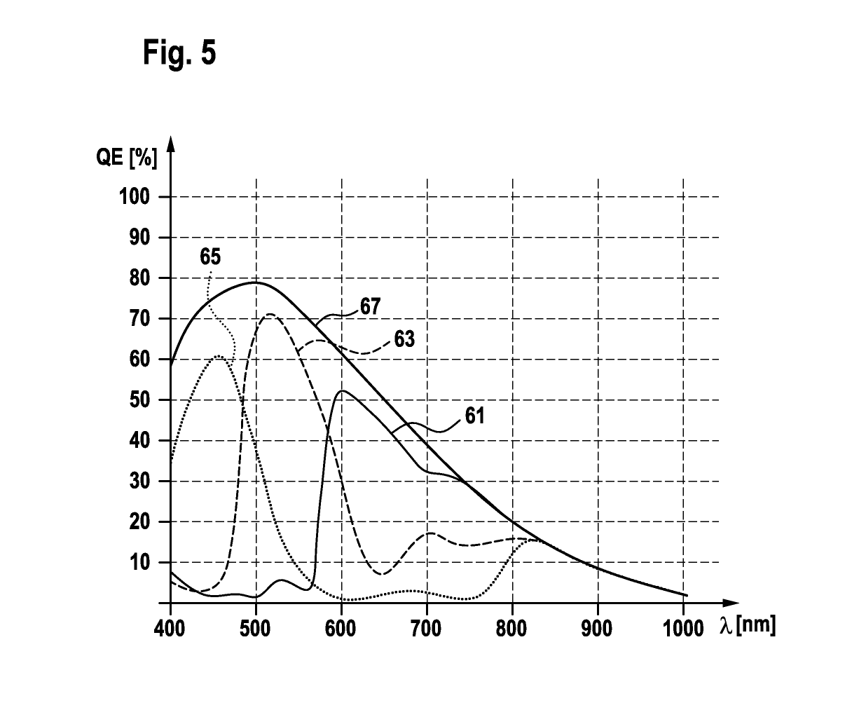

FIG. 5 shows the reproduction of the spectral sensitivity of a black and white version of a CMOS color photo sensor for producing a B/W image with the full physical resolution of the CMOS color photo sensor.

FIG. 1 shows a block circuit diagram of an exemplary embodiment of a digital image recording system with a very simplified block circuit diagram of a digital camera 1, which is basically embodied similarly to a conventional camera, in which by means of a lens 7 serving as an optical imaging system, an object image is exposed on a film that is guided in an image plane. It should be noted that the lens 7 can be a fixed component of the digital camera 1, but can also be embodied as a part that is separate from the digital camera 1 and that can be coupled to the digital camera 1 by means of a known electronic and/or mechanical interface S (mechanical and/or electronic coupling). In particular, the lens 7 can be a component of an optical system such as a microscope; the digital camera 1 can thus be used for recording microscopic images.

In lieu of the conventional film, the digital camera 1 contains a photo sensor 3. The photo sensor 3 is a CMOS sensor array with a multitude of sensor elements 10. The photo sensor 3 is supported in moving fashion in a holder 2 and can be moved relative to the lens 7 in the image plane inside the holder 2 with the aid of piezoelectric elements 5a, 5b serving as shifting actuators. CMOS stands for “complementary metal oxide semiconductor” and describes a generic type of electronic circuits. CMOS photo sensors as such are basically known with regard to their design and function and are therefore not explained in detail here.

The photo sensor 3 has a global shutter, i.e. all of the sensor elements 10 can be exposed at the same time during an exposure interval. Consequently the light intensities detected in the individual sensor elements 10 are all detected at the same time and for the same duration. Consequently a partial image actually constitutes an exposure of the CMOS photo sensor 3.

The operation of the digital camera 1 is controlled by a central control unit 4, which is programmed to perform corresponding functions and operation sequences of the camera by means of software.

In order to control the position of the photo sensor 3 in the image plane, the control unit 4 emits control signals CTRL for triggering the piezoelectric elements 5a, 5b.

The image signals corresponding to the individual partial images (exposures) are transmitted by the photo sensor 3 to the control unit 4 via a data connection DV. Via one or more interfaces 8, the control unit 4 can be connected to an external computer 6 as an image processing unit and/or external image storage means or image output means for outputting image data relating to the result images that are explained in greater detail below and/or raw data of detected partial images.

It should be noted that the functions of the image processing unit can also be implemented in the control unit 4. The following description therefore basically applies to both alternatives. It is clear to the person skilled in the art that basically all functions of the image recording system that are implemented essentially by means of software can be present both in the control unit 4 and/or in the computer 6. In practice, all functions that relate to the control of components of the digital camera 1 may be implemented in the control unit 4. All functions relating to the image processing of the partial images may be implemented in the computer 6 that serves as the image processing unit. The digital camera 1 may supply the partial images to the computer 6 via a data connection. The computer 6 can basically be a conventional computer system such as a personal computer.

In order to improve the imaging quality in color result images, an as such known IR barrier filter 11 may be situated in front of the photo sensor 3 in the beam path of the incident light. The IR barrier filter 11 can be coupled to an actuator 13, which can be controlled by the control unit 4 via a control line SL (or by means of the computer 6 via the control unit 4). The actuator 13 is able to move a support 12—to which the IR barrier filter 11 is fastened—perpendicular to the beam path in order to thus move the IR barrier filter 11 entirely out of the beam path or back into it again. Alternatively, the arrangement composed of the actuator 13 and IR barrier filter 11 can be embodied so that the IR barrier filter 11 can be pivoted or folded out of the beam path. It should be noted that the actuator 13 is optional. The IR barrier filter 11 can also be installed in the digital camera 1 in stationary fashion (i.e. so that it does not move during operation). Finally, it is also possible for the IR barrier filter to be a separate part, which can be inserted between the digital camera 1 and the lens 7 or can be attached to the lens. The IR barrier filter can also be a component of the lens 7, which can be coupled to the digital camera 1 or attached to it in a stationary fashion.

In the upper part, FIG. 2 shows the photo sensor 3 of FIG. 1 in greater detail. The photo sensor 3 can be moved in the vertical direction (Y direction, FIG. 1) relative to the holder 2 by means of the piezoelectric actuator 5b; the piezoelectric actuator 5a for sliding the photo sensor 3 in the horizontal direction (X direction, FIG. 1) relative to the holder 2 has been left out for the sake of simplicity.

The control unit 4 of the digital camera 1 can be configured, based on a plurality of chronologically successive partial images (exposures) corresponding to the embodiments explained at the beginning, to use at least three partial images to produce an associated color result image or black and white (B/W) result image or a sequence of result images (result image sequence) or to supply the partial image data, which is embodied in the form of raw data, for the corresponding processing to the external computer 6 serving as the image processing unit for offsetting purposes.

FIGS. 2 through 4 show individual sensor elements (10, FIG. 1) of the photo sensor 3, which are depicted in exaggerated fashion for illustration purposes, in order to explain the operating modes of the image recording system proposed here. It should be noted that a significantly small number of sensor elements (10, FIG. 1) is shown in FIGS. 1 through 4 merely for the sake of a clearer depiction. Real photo sensors 3 have a greater sensor element density.

FIG. 2 is a top view from the direction of the optical imaging system on the surface of the photo sensor 3 of the digital camera 1 der FIG. 1. The photo sensor 3 comprises a sensor array with the individual sensor elements (10, FIG. 1) and respective color mosaic filters of a Bayer color mosaic filter. A “G” on a sensor element means that the relevant sensor element, because of the preceding color filter element, is sensitive to green-colored light (G). Each second sensor element is sensitive to green-colored light in both the vertical direction (Y direction, FIG. 1) and the horizontal (X direction, FIG. 1). In other words, the green filter elements are arranged over the sensor elements of the sensor array in a fashion that corresponds to the fields of one of the two colors of a checkerboard. Of the remaining sensor elements 50% are provided with a color filter element for blue-colored light (B) and 50% are provided with a color filter element for red-colored light (R) so that in every other row and every other column, every other sensor element is configured for blue-colored (B) or red-colored (R) light.

In one particular embodiment, between two successive exposures, the photo sensor 3 is shifted vertically by one image point (pixel) raster spacing, i.e. by one sensor element, between the positions A and B.

After the recording of the first partial image A₁ at position A according to FIG. 2, the photo sensor 3 is shifted by one vertical image point raster spacing, i.e. by one sensor element in position B, before the recording of the second partial image B₂ is carried out. After another shift of the photo sensor 3 from position B to position A, the recording of the third partial image A₃ is carried out. The respective shifting is carried out between the exposure intervals.

In the lower part of FIG. 2, the color separations for the colors red, green, and blue that can be produced based on the three partial images A₁, B₂, A₃ are shown from right to left. Because of the shifting by one sensor element spacing in the vertical direction, only the image points (pixels) in the image region labeled 9 are used for the result image. Consequently, the color separations for red and blue contain the color information for red (R) and blue (B) for every other Image point and the color separation for green contains the color information for green (G) for every image point.

FIG. 3 shows the combination of two respective successive partial images of a sequence of recorded images in order to produce a result image sequence with the same image rate. Since an image sequence is composed of at least two result images, at least three recorded images (partial images) are required for this as well. In the upper left part, FIG. 3 shows eight partial images A₁, B₂, A₃, B₍₂ᵢ₎, A₍₂ᵢ₊₁₎, B . . . from left to right in chronological order, which have been respectively recorded in alternating fashion in the positions A or B.

In FIGS. 2 and 3, it is first clear that with two respective successive partial images at positions A and B, there are two color separations each for the sensor elements of the seven middle sensor rows; for each image point, the color information for green is present and the second color information for either red or for blue is present. This does not apply to the top and bottom rows of the sensor elements since based on the shifting of the photo sensor 3, the top and bottom rows are only exposed one time.

In accordance with relatively simple computing rules, it is possible, for the image points corresponding to the sensor elements of the seven middle rows and based on the existing color information for the respective sensor element and the color information existing for the adjacent sensor elements, for the control unit 4 or the computer 6 to calculate the respective third, still missing color information for each image point; one possible computing rule, for example, is known from DE 197 02 837 C1.

FIG. 2 also shows how the control unit 4 (or the external computer 6) may be configured to produce a color result image by combining the three partial images A₁, B₂, and A₃. To this end, the first partial image A₁ and the third partial image A3 can be first averaged in that an intermediate partial image A* is calculated based on 50% of A₁ and 50% of A₃. The intermediate partial image A* can then be combined with the second partial image B₂ in order to produce the color result image. In other words, the partial images A₁ and A₃ each make a 50% contribution and the partial image B₂ makes a 100% contribution to the color result image.

FIG. 3 shows the production of a result image sequence with individual images E₁, E₂, E₃, E₆, E . . . etc., where each partial image may be combined with the preceding partial image to produce an individual image of the result image sequence. To that end, the control unit 4 (or the external computer 6) is configured, in an operating mode, to record the result image sequence by triggering the piezoelectric element 5b so that the photo sensor 3 periodically alternates in the image plane, respectively between the recording of two successive partial images A₁, B₂, A₃, B₄, . . . , B₍₂ᵢ₎, A₍₂ᵢ₊₁₎, . . . between the two positions A and B, and combines each of the partial images with the partial image preceding it in order to produce an individual color image E₁, E₂, E₃, . . . , E₆, E₇ . . . etc. of the result image sequence. In other words, a first partial image A₁ at position A and a second partial image B₂ at position B are combined to produce a color result image E₁. The second partial image B₂ at position B and a third partial image A₃ once again at position A are combined to produce a color result image E₂ of the result image sequence. In other words, A₃+B₄→E₃, B₄+A₅→E₄ etc. In this way, the image sequence is produced with an image rate that is just as high as the exposure rate of the partial images.

FIG. 4 shows one possible combination of four respective successive partial images of a high-frequency recorded image sequence to produce a result image sequence that is relatively low-frequency in comparison. In other words, in this exemplary embodiment, an even number of four successive partial images, e.g. Aₙ₋₁, Bₙ₊₀, Aₙ₊₁, Bₙ₊₂, are prorated or combined according to the principle explained above in order to produce a single color image Eₘ₊₀ of the result image sequence.

To that end, the control unit 4 (or the external computer 6) is configured, for example, to combine the partial images Aₙ₋₁ and Aₙ₊₁ through a weighted averaging, in which the partial image Aₙ₊₁ is weighted at 25% and the partial image Aₙ₊₁ is weighted at 75%, in order to produce an intermediate partial image A*. In a similar way, the partial images Bₙ₊₀ and Bₙ₊₂ are combined into an intermediate partial image B* by means of a corresponding weighted averaging. The intermediate partial images A* and B* are then prorated in the above-explained way in order to produce the single color image Eₘ₊₀ of the result image sequence.

The above-described weighting of the individual partial images causes the average exposure time for the averaged image A* obtained from the partial images at position A (partial image series Aₙ₋₁ and Aₙ₊₁) coincides with the average exposure time for the averaged image B* obtained from the partial images at position B (partial image series Bₙ₊₀ and Bₙ₊₂).

If each partial image is prorated or combined with the 3 preceding partial images in order to produce a single image of the result image sequence, then this yields a result image rate that coincides with the image rate of the partial images. If the digital camera 1 is able to produce partial images at very high partial image rates, then it is possible to achieve a low result image rate by using only every m^{th} partial image with its preceding three partial images in order to produce a single image of the result image sequence.

For example, the digital camera 1 can be used to record a movie with a required image rate of 24 frames/sec. To that end, the scene is recorded, for example, at 96 partial images/sec, which images are averaged according to the above-explained principles and prorated or combined to produce the individual images of the result image sequence.

Through the chronological interaction of the multiple partial images, it is possible to largely compensate for uniform movements.

With moving objects or a moving camera, in a first approximation relative to the exposure times, it is true that the movement occurs at a constant speed. The proposed processing of partial images therefore makes use of the fact that an object that is moving at a constant speed has the same center-of-gravity locus in the middle partial image of the three partial images as it does in an averaged partial image calculated based on the preceding partial image and the third partial image after it. In a corresponding fashion, the principle can be expanded to include a higher number of more than three successive partial images recorded at the two positions A and B at chronologically equidistant times.

As already explained above, as higher the number of partial images for calculating a color result image based on the chronological interaction of the partial image sequences as better movement compensation.

But it is also possible, as needed, to set the brightness dynamics of the digital camera 1. To this end, the control unit 4 is configured to set a required brightness dynamic range to be used in recording a result image sequence or an individual result image. To this end, the control unit 4 is configured (i) to set the number n of partial images, where n is greater than or equal to three, that are used in order to calculate a single result image or an individual result image of the result image sequence and (ii) to set the exposure time for the individual partial images so that the sensor elements do not reach saturation during the recording of the individual partial images.

In the recording of an image sequence, it is therefore possible to compensate for a uniform chronological change in the image brightness, as can be produced, for example, by a change in lighting intensity of the scene.

But this may be also advantageous in the recording of individual images, for example, in microscopy, where interfering effects in the result image can occur due to the optical whitening of fluorescent colorants.

The above-explained operating mode of the digital camera 1 is therefore suitable for both a film camera (movie camera) for producing image sequences/video sequences and also for producing high-quality shots (individual images) of the kind used in microscopy, for example.

FIG. 5 shows the principle of producing a B/W result image with the physical resolution of the CMOS color sensor 3 according to another possible operating mode of the image recording system from FIG. 1.

FIG. 5 shows the spectral sensitivities 61, 63, 65 of the individual sensor elements of the photo sensor 3 based on the respective preceding filter elements of the Bayer color mosaic filter for the colors red (R), green (G), and blue (B) in comparison to the curve 67 of the spectral sensitivity of the photo sensor 3 in a black and white version, i.e. without the Bayer color mosaic mask. The spectral sensitivity indicates the quantum efficiency, i.e. the probability with which an electron in the respective sensor element will be released by the photoelectrical effect, so that the photon can be detected. Consequently, the individual sensor elements of the photo sensor 3 from FIGS. 2 through 4 are correspondingly sensitive to the respectively preceding color filter element for one of the three primary colors blue, green, and red.

The control unit 4 (or the computer 6) may be configured—at least in the B/W operating mode—to trigger the actuator 13, if provided, so that the IR barrier filter 11 is removed from the beam path for light that strikes the photo sensor 3 during a recording.

By way of example, the filter curve 65 of a filter element for blue light may typically extend from approximately 400 nm to 550 nm, the filter curve 63 for green light may typically extend from 450 nm to 650 nm, and the filter curve 61 for red light may typically extend from approximately 550 nm to 900 nm or to 700 nm when using the additional infrared barrier filter that is conventional in color cameras.

In accordance with the fact that the human eye is the most sensitive to the color green, the filter curve of sensor elements with a color filter element for the color green occupies the largest range. For this reason, in the herein described embodiment, a Bayer color mosaic filter mask was selected in which 50% of the filter elements were designed for the color green. As explained at the beginning, by combining at least two partial images that were recorded with photo sensors 3 that have been shifted by one sensor element in the vertical (or alternatively in the horizontal) direction, the image recording system is able—for all image points of a result image—to detect color information for the color green as well as color information for the color red or blue. As discussed herein above, the missing third color can be calculated for each image point according to known computing rules.

Correspondingly, the control unit 4 (or the external computer 6) is configured, in a B/W operating mode, to combine the partial images A₁ and B₂ recorded at the two positions A and B (as shown in FIG. 3) in order to produce a result image. But now, the respective luminance information for each image point can be derived by combining the detected and calculated color information for red, green, and blue for each image point in the fashion of a maximum operator. In other words, in the B/W operating mode, the control unit 4 of the digital camera 1 (or the connected external computer 6) may be configured to combine the color information that is known for each image point functionally in the fashion of a maximum operator with the respective luminance information for the respective image point of the B/W result image.

Since the image recording system detects—without color interference—information for each image point at the physical resolution of the photo sensor 3, B/W images can be produced in this way, which have turned out to be useful, for example, in the field of microscopy. Correspondingly, the image recording system may be used as a dual-mode camera system for microscopy, with which it is possible to produce not only true-color color images of enlargements, as well as equally high-resolution B/W images with the physical resolution of the photo sensor 3.

Finally, it should also be noted that the resolution of the digital camera 1 can also be increased by means of microscanning, as is known from DE 100 33 751 B4. To this end, in a corresponding mode for increasing the resolution, the control unit 4 may also be configured to control the piezoelectric actuators 5a, 5b for a recording of additional partial images in such a way that the object image is shifted among several positions relative to the photo sensor 3 with respect to a reference point, respectively by only a fraction of the distance between two adjacent sensor elements (10, FIG. 1) in the vertical and/or horizontal direction between the recording of individual partial images. It is consequently possible to produce result images, which have a higher resolution than the physical resolution of the photo sensor 3. In addition, it is also possible to use the principles presented here for combining a plurality of partial images.

In addition, in order to avoid unwanted blurring of the image, e.g. in shots of faces, this can be overlaid with the method known from DE 100 33 751 B4, in that the piezoelectric actuators are set into a correspondingly suitable movement not only between, but also during the individual exposures the photo sensor 3.

1. An image recording system, comprising:
a digital camera with a two-dimensional global shutter CMOS sensor array with photosensitive sensor elements; at least one shifting actuator, which is configured to produce a relative shifting between an object image and the sensor array between two positions; and a control unit, which is configured to control the shifting means between the recording of successive partial images, taking into account a color mosaic filter placed in front of the sensor elements for the simultaneous recording of a red, green, and blue color separation in such a way that by means of successive partial images recorded at the two positions for all image points of an image obtained by combining the partial images, color information for green is available; and
an image processing unit, which is coupled to the digital camera and is configured to calculate a result image or a result image sequence, which includes at least two result images, based on at least three successive partial images, which are recorded in alternating fashion at the two positions at chronologically equidistant intervals, and the first partial image and the third partial image have been recorded at the same position.

2. The image recording system according to claim 1, wherein, in an operating mode for recording a result image sequence,
the control unit is configured to control the at least one shifting actuator so that the sensor array periodically switches, in the image plane, respectively between each pair of successive shots between the two positions, and
the image processing unit is configured to combine each partial image with two preceding partial images in order to produce a color result image of the result image sequence.

3. The image recording system according to claim 1, wherein, in an operating mode for recording a result image sequence,
the image processing unit is configured to respectively combine at least three successive partial images recorded at the two positions at chronologically equidistant intervals in order to produce a color result image of the result image sequence with a lower image rate than the recorded image rate of the partial images.

4. The image recording system according to claim 1, wherein, in an operating mode for recording a result image sequence,
the image processing unit is configured to combine a number of greater than three successive partial images recorded at the two positions at chronologically equidistant times in order to produce a color result image of the result image sequence.

5. The image recording system according to claim 1,
wherein the control unit or the image processing unit is configured, when combining at least three partial images, first to combine the partial images for each of two positions; and
wherein a weighting for the individual partial images to be combined is preferably carried out so that an average exposure time for the combined partial images coincides at each of two positions.

6. The image recording system according to claim 1, wherein the control unit or the image processing unit is configured, in order to set a brightness dynamic range,
to set a number n of partial images, where n is greater than or equal to three, for calculating a result image or one result image of a result image sequence, and
to set the exposure times for the partial images so that the sensor elements do not reach saturation during the recording of each of the partial images.

7. The image recording system according to claim 1, wherein the digital camera further comprises an infrared (IR) barrier filter element which is placed in front of the sensor array.

8. The image recording system according to claim 7, wherein the IR barrier filter element is coupled to at least one actuator, which is configured to position the IR barrier filter element in front of the sensor array or to move it out of the way of the sensor array.

9. The image recording system according to claim 1, wherein the control unit or the image processing unit, in a B/W operating mode, is configured, by means of at least two successive partial images recorded at the two positions, to derive luminance information for each image point of the result image or for each result image of the result image sequence by combining color information for red, green, and blue that has been detected and/or calculated for the image point.

10. The image recording system according to claim 9, wherein the control unit or the image processing unit, in the B/W operating mode, is configured to derive the luminance information for each image point of the result image or for each result image of the result image sequence by combining the color information for red, green, and blue for the image point, particularly in the fashion of a maximum operator.

11. The image recording system according to claim 9, wherein the digital camera further comprises an infrared (IR) barrier filter element which is placed in front of the sensor array, wherein the IR barrier filter element is coupled to at least one actuator, which is configured to position the IR barrier filter element in front of the sensor array or to move it out of the way of the sensor array, and wherein, in the B/W operating mode, the control unit or the image processing unit is configured to remove the infrared barrier filter element from in front of the sensor array.

12. The image recording system according to claim 1, wherein the digital camera can be coupled to an optical imaging system in order to image the object image on the sensor array.

13. The image recording system according to claim 12, wherein the optical imaging system constitutes or is part of a set of microscopy optics.

14. The image recording system according to claim 1, wherein the control unit is integrated into the image processing unit or the image processing unit is integrated into the control unit.

15. An image processing unit comprising a computer, which computer is configured for being coupled to a digital camera and for receiving at least three successive partial images from the digital camera, and which is configured to calculate a result image or a result image sequence, which includes at least two result images, based on the at least three successive partial images,
wherein the successive partial images are obtainable by the digital camera comprising a two-dimensional global shutter CMOS sensor array with photosensitive sensor elements; at least one shifting actuator, which is configured to produce a relative shifting between an object image and the sensor array between two positions; and a control unit, which is configured to control the shifting means between the recording of successive partial images, taking into account a color mosaic filter placed in front of the sensor elements for the simultaneous recording of a red, green, and blue color separation in such a way that by means of successive partial images recorded at the two positions for all image points of an image obtained by combining the partial images, color information for green is available; and wherein the at least three successive partial images are recorded in alternating fashion at two positions at chronologically equidistant intervals, and the first partial image and the third partial image have been recorded at the same position.

16. Use of an image recording system according to claim 1 for recording at least one of microscopic images, video sequences and movies.

17. Use of an image processing unit according to claim 15 for recording at least one of microscopic images, video sequences and movies.
